(19) United States
(12) Patent Application Publication
(10) Pub. No.: US 2003/0142143 A1
(43) Pub. Date: Jul. 31, 2003

(54) Varying heights of application images to convey application status

(75) Inventors: Michael Wayne Brown, Georgetown, TX (US); Andrew Douglas Hately, Austin, TX (US); Kelvin Roderick Lawrence, Round Rock, TX (US); Michael A. Paolini, Austin, TX (US)

Correspondence Address: Marilyn Smith Dawkins, International Business Machines Corporation, Intellectual Property Law Dept., Internal Zip 4054, 11400 Burnet Road, Austin, TX, 78758, US

(73) Assignee: International Business Machines Corporation, Armonk, NY (US)

(21) Appl. No.: 10/058,300

(22) Filed: Jan. 28, 2002

(51) Int. Cl. G09G 5/00

(52) U.S. Cl. 345/836; 345/835; 345/440.2

(57) ABSTRACT

A method, system and program for varying the heights of application images to convey application status are provided. At least one type of activity is detected for an application image associated with an application opened in a graphical interface. A three-dimensional height of the application image in said graphical interface is graphically adjusted to represent at least one type of activity, such that at least one type of activity is graphically distinguished for an application from the application image.

### CROSS-REFERENCE TO RELATED APPLICATIONS

The present application is related to the following co-pending applications, which are filed on even date herewith and incorporated herein by reference:

(1) U.S. patent application Ser. No. ______ (Attorney Docket No. AUS920010513US1); and

(2) U.S. patent application Ser. No. ______ (Attorney Docket No. AUS920010514US1);

(3) U.S. patent application Ser. No. ______ (Attorney Docket No. AUS920010515US1);

(4) U.S. patent application Ser. No. ______ (Attorney Docket No. AUS920010516US1);

(5) U.S. patent application Ser. No. ______ (Attorney Docket No. AUS920010517US1);

(6) U.S. patent application Ser. No. ______ (Attorney Docket No. AUS920010518US1);

(7) U.S. patent application Ser. No. ______ (Attorney Docket No. AUS920010519US1);

(8) U.S. patent application Ser. No. ______ (Attorney Docket No. AUS920010520US1);

(9) U.S. patent application Ser. No. ______ (Attorney Docket No. AUS920010521US1);

(10) U.S. patent application Ser. No. ______ (Attorney Docket No. AUS920010524US1); and

(11) U.S. patent application Ser. No. ______ (Attorney Docket No. AUS920010525US1).

### BACKGROUND OF THE INVENTION

1. Technical Field

The present invention relates in general to computer systems and, in particular, to graphical user interfaces. Still more particularly, the present invention relates to varying the heights of application icons to convey application status.

2. Description of the Related Art

Most computer systems include multiple types of software for controlling the functions of the computer system. A first type of software is system software (operating systems), which controls the workings of the computer. A second main type of software is applications, such as word processing programs, spreadsheets, databases, and browsers, which perform the tasks for which people use computers. In addition, a computer system may include network software, which enables groups of computers to communicate, and language software, which provides programmers with the tools they need to write programs.

Software contains many instructions typically executed by a processor and other hardware within a computer system. As instructions are executed, the status or progress of multiple parts of the computer system is often monitored. In particular, the status is the condition, at a particular time, of any of numerous elements of computing including, but not limited to, a device, a communications channel, a network station, a software program, a bit, or another element. A status may be utilized to report on or to control computer operations.

Most system software provides a graphical user interface (GUI) for controlling a visual computer environment. The GUI represents programs, files, and options with graphical images, such as icons, menus, and dialog boxes on the screen. Graphical items defined within the GUI work the same way for the user in most software because the GUI provides standard software routines to handle these elements and report the user's actions.

A typical graphical element defined by a GUI is a window or other defined area of a display containing distinguishable text, graphics, video, audio and other information for output. A display area may contain multiple windows associated with a single software program or multiple software programs executing concurrently.

In addition, a GUI may define a selectable graphical element that identifies an application currently in use. Such selectable graphical elements may be referred to as selectable application images. In many cases, the selectable application images are displayed in a sequence along a side of the display area or within a pop-up or pull-down menu.

Where multiple applications are in use, each of the multiple applications may be identified by an application image. However, current use of application images to identify an application currently in use are limited in that the selectable graphical elements only identify that applications are running.

Another limitation of application images is that the application images are displayed in the order in which applications were opened, rather than the current ordering of the applications. Typically, windows associated with applications are layered in a particular order, referred to as the z-order, where the windows displayed at the top of the z-order are the most recently opened or may be placed at the top of the z-order according to other criteria. However, the ordering of the application images does not reflect the current z-order of windows.

Further, a limitation of application images is that the application images do not identify the resources utilized by each of the running applications. Each application may utilize multiple resources, however the user is typically required to open a separate window to display application resource usage.

Therefore, in view of the foregoing, it would be advantageous to provide a method, system, and program for utilizing an application image to illustrate multiple types of activity, such as the z-order of applications and resource usage by applications.

### SUMMARY OF THE INVENTION

In view of the foregoing, it is therefore an object of the present invention to provide an improved computer system.

It is another object of the present invention to provide an improved graphical user interface.

It is yet another object of the present invention to provide a method, system and program for varying the heights of application icons to convey application status.

According to one aspect of the present invention, at least one type of activity is detected for an application image associated with an application opened in a graphical interface. A three-dimensional height of the application image in said graphical interface is graphically adjusted to represent at least one type of activity, such that at least one type of activity is graphically distinguished for an application from the application image.

One type of activity detected for an application image includes adjustment of the z-order of multiple open applications and usage of at least one resource by the multiple open applications.

At least one level of height may be graphically adjusted for the application image. In addition, a range of shading may be applied to illustrate the adjusted height of the application image. Further, a quantity associated with the adjustment in height may be illustrated.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system with which the method, system and program of the present invention may advantageously be utilized;

FIG. 2 illustrates a graphical representation of a window in which activity associated with application is graphically distinguished in accordance with the method, system, and program of the present invention;

FIGS. 3a-3b depict a graphical representation of a window in which the resource usage of each application is graphically displayed by application images in accordance with the method, system, and program of the present invention; and

FIG. 4 illustrates a high level logic flowchart of a process and program for varying the heights of application images to indicate types of activity in accordance with the method, system, and program of the present invention.

### DETAILED DESCRIPTION OF THE PREFERRED EMBODIMENT

A method, system and program for varying the heights of application images to convey application status are provided. In the present invention, activity included in an application status may include adjustments to the graphical display, such as adjustments in the z-order of windows. In addition, activity may include the use of a resource by a system element.

In the present invention, a system element may include, but is not limited to, a software element, a hardware element, or a network element associated with a computer system. The present invention is particularly useful for software applications utilizing large amounts of resources and network software.

Software elements include, but are not limited to, software applications, operating systems, language programs and other code based documents executing within a computer system, accessible to a computer system, or accessed by a computer system. Hardware elements include, but are not limited to, hardware functioning within a computer system and peripherals accessible to a computer system. Network elements include, but are not limited to, network software, network hardware and network interfacing.

In addition, in the present invention, “resource usage” may include, but is not limited to, usage of software elements, hardware elements, and network elements. In particular, displaying resource usage is advantageous where specified for usage of memory, graphics cards, sound cards, printers, operating systems, buses, input devices, output devices, number of CPUs, number of threads, direct access storage devices (DASDs), and net bandwidth and other software, hardware, and network resources. As will be understood by one skilled in the art, the actual monitoring of the usage of a resource may be performed by hardware or software elements within a computer system or received as input to a computer system. In addition, as will be understood by one skilled in the art, the conversion of the usage of a resource to a graphical representation of status may be performed by hardware or software within a computer system or received as input to a computer system.

Further, for the purposes of this invention, a “window” may be a traditional rectangular region on a display in which data is displayed, as well as smaller sub-regions, such as pop-up, pull-down, or other menus, icons, symbols, or other display elements, and objects, generally. In addition, a minimized “window” may be represented by a selectable icon within a user interface.

Accordingly, it will be appreciated that the apparatus and method of the present invention has application to any object displayed, regardless of the shape, size or function of the object in any particular computer display system. In addition, it will be appreciated that when a window is referenced, the software controlling the information within the window is also referenced and that while the present invention refers to minimization of windows, that multiple windows may be minimized into a single icon and that a software application may be minimized into a single icon.

Further, it will be appreciated that multiple windows may be opened within a display area, where the multiple windows are displayed in association with multiple independent software applications. The graphical elements associated with the software application may be hidden, while the windows opened in association with the software application remain open, such that windows from multiple hidden software applications may overlap one another.

Moreover, it will be appreciated that a graphical listing of currently open applications may be displayed, whether or not windows associated with those applications are open. Activity associated with each of the applications is preferably graphically represented with the graphical application image of currently open applications. A single type of activity or multiple types of activity may be graphical represented for each application. In particular, different types of shading may be utilized to graphically represent activity. Shading may include, but is not limited to, hues, colors, gradients, transparency, three-dimensional effects, and other graphical features supported by a system.

Transparency is a graphical shading feature that is particularly advantageous to the present invention when graphically describing application activity. By making an application image appear transparent on a computer screen, other elements below the application image are visible through the application image. Further, the transparency of an application image may be adjusted from opaque to totally transparent.

Typically, the transparency attribute is stored with color values in an alpha channel. Then, when calculating the appearance of a given pixel, the graphic processor uses the alpha channel values to determine the pixel's color through a process termed alpha blending. Through alpha blending, the process adds a fraction of the color of the transparent object set by the alpha channel value to the color of the window element. Mixing the colors together gives the appearance that the window element is seen through a layer of the transparent application image. In addition to alpha blending, additional shading may be added to create shadows and other graphical images to cue the viewer to the position of the transparent application image.

In the following description, for the purposes of explanation, numerous specific details are set forth to provide a thorough understanding of the present invention. It will be apparent, however, to one skilled in the art that the present invention may be practiced without these specific details. In other instances, well-known structures and devices are shown in block diagram form to avoid unnecessarily obscuring the present invention.

### Hardware Overview

The present invention may be executed in a variety of systems, including a variety of computing systems and electronic devices under a number of different operating systems. In one embodiment of the present invention, the computing system is a portable computing system such as a notebook computer, a palmtop computer, a personal digital assistant, a telephone or other electronic computing system that may also incorporate communications features that provide for telephony, enhanced telephony, messaging and information services. However, the computing system may also be, for example, a desktop computer, a network computer, a midrange computer, a server system or a mainframe computer. Therefore, in general, the present invention is preferably executed in a computer system that performs computing tasks such as manipulating data in storage that is accessible to the computer system. In addition, the computer system preferably includes at least one output device and at least one input device.

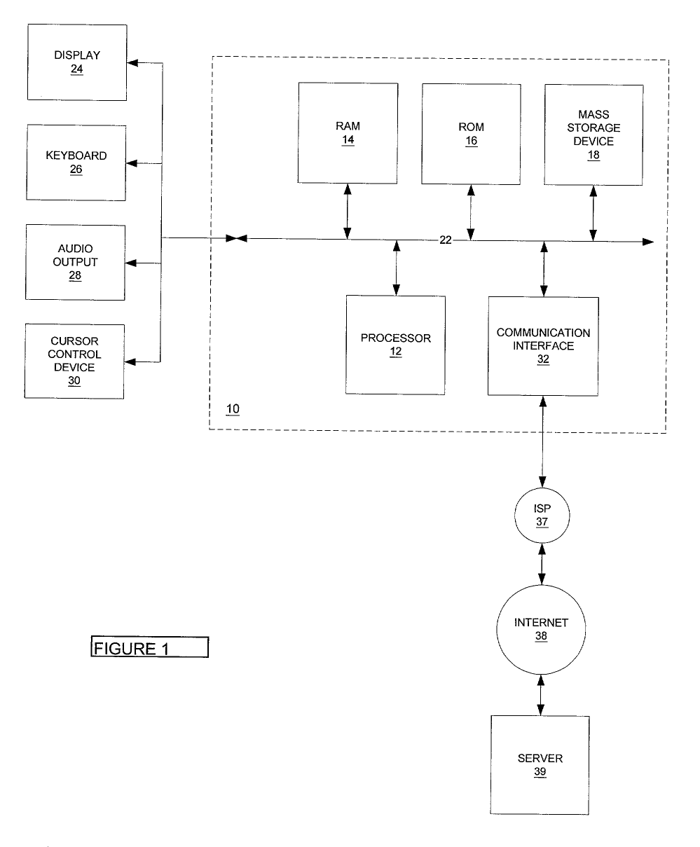

Referring now to the drawings and in particular to FIG. 1, there is depicted one embodiment of a computer system with which the method, system and program of the present invention may advantageously be utilized. Computer system 10 comprises a bus 22 or other communication device for communicating information within computer system 10, and at least one processing device such as processor 12, coupled to bus 22 for processing information. Bus 22 preferably includes low-latency and high-latency paths that are connected by bridges and controlled within computer system 10 by multiple bus controllers.

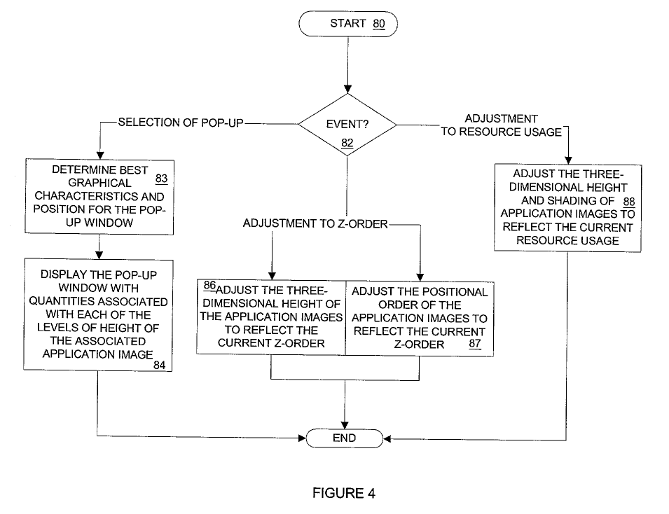

Processor 12 may be a general-purpose processor such as IBM's PowerPC™ processor that, during normal operation, processes data under the control of operating system and application software stored in a dynamic storage device such as random access memory (RAM) 14 and a static storage device such as Read Only Memory (ROM) 16. The operating system preferably provides a graphical user interface (GUI) to the user. In a preferred embodiment, application software contains machine executable instructions that when executed on processor 12 carry out the operations depicted in the flowchart of FIG. 4 and others described herein. Alternatively, the steps of the present invention might be performed by specific hardware components that contain hardwire logic for performing the steps, or by any combination of programmed computer components and custom hardware components.

The present invention may be provided as a computer program product, included on a machine-readable medium having stored thereon the machine executable instructions used to program computer system 10 to perform a process according to the present invention. The term “machine-readable medium” as used herein includes any medium that participates in providing instructions to processor 12 or other components of computer system 10 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM), a digital video disc-ROM (DVD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 10 can read and which is suitable for storing instructions. In the present embodiment, an example of non-volatile media is storage device 18. Volatile media includes dynamic memory such as RAM 14. Transmission media includes coaxial cables, copper wire or fiber optics, including the wires that comprise bus 22. Transmission media can also take the form of acoustic or light waves, such as those generated during radio wave or infrared data communications.

Moreover, the present invention may be downloaded as a computer program product, wherein the program instructions may be transferred from a remote computer such as a server 39 to requesting computer system 10 by way of data signals embodied in a carrier wave or other propagation medium via a network link 34 (e.g., a modem or network connection) to a communications interface 32 coupled to bus 22. Communications interface 32 provides a two-way data communications coupling to network link 34 that may be connected, for example, to a local area network (LAN), wide area network (WAN), or as depicted herein, directly to an Internet Service Provider (ISP) 37. In particular, network link 34 may provide wired and/or wireless network communications to one or more networks.

ISP 37 in turn provides data communication services through the Internet 38 or other network. Internet 38 may refer to the worldwide collection of networks and gateways that use a particular protocol, such as Transmission Control Protocol (TCP) and Internet Protocol (IP), to communicate with one another. ISP 37 and Internet 38 both use electrical, electromagnetic, or optical signals that carry digital or analog data streams. The signals through the various networks and the signals on network link 34 and through communication interface 32, which carry the digital or analog data to and from computer system 10, are exemplary forms of carrier waves transporting the information.

Further, multiple peripheral components may be added to computer system 10. For example, an audio output 28 is attached to bus 22 for controlling audio output through a speaker or other audio projection device. A display 24 is also attached to bus 22 for providing visual, tactile or other graphical representation formats. Display 24 may include both non-transparent surfaces, such as monitors, and transparent surfaces, such as headset sunglasses or vehicle windshield displays.

A keyboard 26 and cursor control device 30, such as a mouse, trackball, or cursor direction keys, are coupled to bus 22 as interfaces for user inputs to computer system 10. It should be understood that keyboard 26 and cursor control device 30 are examples of multiple types of input devices that may be utilized in the present invention. In alternate embodiments of the present invention, additional input and output peripheral components may be added.

### Activity Graphically Displayed According to Application

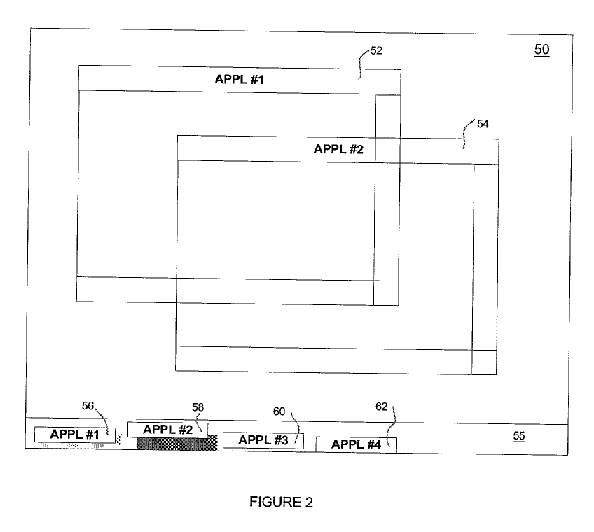

With reference now to FIG. 2, there is depicted a graphical representation of a window in which activity associated with application is graphically distinguished in accordance with the method, system, and program of the present invention. As illustrated, a graphical interface 50 includes multiple windows 52 and 54. Window 52 is open in association with “appl #1” and window 54 is open in association with “appl #2”. “Appl #1” is the title associated with an application image 56 and “appl #2” is the title associated with an application image 58.

Additional application images 60 and 62 are also depicted within window 50. Preferably, each of application images 56, 58, 60 and 62 are displayed to represent an application that is currently open within the system. Advantageously, an application may be running within a system without displaying windows in association with the application.

According to one advantage of the present invention, graphical characteristics of application images 56, 58, 60, and 62 may be adjusted in order to indicate the types of activity associated with the applications. In the present example, the graphical characteristic adjusted is the height of each of application images 56, 58, 60, and 62.

In the present example, the heights of each of application images 56, 58, 60, and 62 are adjusted three-dimensionally in order to indicate the z-order of the applications and/or windows associated with the applications. Application image 58 is three-dimensionally displayed higher than application image 56, indicating that “appl #2” is higher in the z-order than “appl #1”.

In particular, where windows, such as windows 52 and 54, are transparent, it may be difficult to determine the z-order of the windows, even with shading added to windows that are higher in the z-order. In the example, window 54, associated with “appl #2” is shaded in order to indicate z-ordering. However, z-ordering is also graphically distinguished by the heights of application images 56 and 58.

In alternate embodiments of the present invention, to depict the z-order of applications and/or windows associated with applications, the actual order, for example from left to right, of application images 56, 58, 60, and 62 may be adjusted to represent the z-ordering. In addition, in alternate embodiments of the present invention, the shading associated with the varying heights of application images 56 may indicate a type of activity.

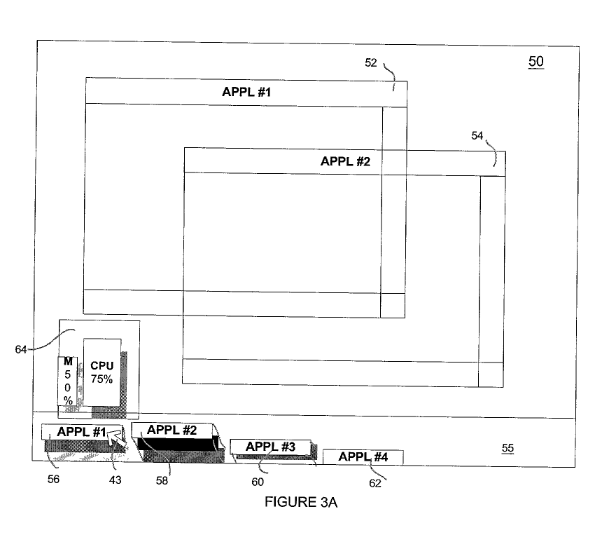

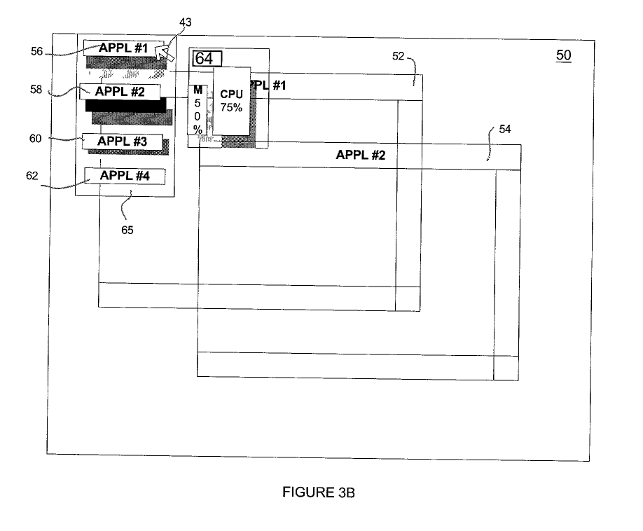

Referring now to FIGS. 3a-3b, there is depicted a graphical representation of a window in which the resource usage of each application is graphically displayed by application images in accordance with the method, system, and program of the present invention.

According to one advantage of the present invention, the three-dimensional heights of application images are adjusted to indicate multiple types of activity. In the present example, two types of activity are displayed for each of application images 56, 58, 60 and 62. Advantageously, each of the types of activity is graphically represented by a level of height of application images 56, 58, 60, and 62. Each of the levels of height may be shaded in order to distinguish levels and in order to represent the height of each of the levels.

In particular, where resource usage is the type of activity illustrated, the three-dimensional heights of application images 56, 58, 60, and 62 are varied in comparison with one another, such that the application image representing the application utilizing the largest portion of a resource is elevated above other application images.

In addition, in particular, where multiple types of activities are depicted, such as multiple types of resource usage, a particular shading characteristic is attributed to each of the types of resource usage. For example, a first level may be attributed with a shading characteristics of a first color, such that resource usage attributed to the first level is distinguished by the first color. Then, a second level may be attributed with a shading characteristic of a second color, such that resource usage attributed to the second level is distinguished by the second color. While in the present invention two levels of three-dimensional height are depicted, in alternate embodiments, any number of levels of any dimensioned height may be illustrated.

According to another advantage of the present invention, while relative resource usage by applications is graphically distinguished by the heights of application images, a user may also select to view a numerical indicator of the types of activity associated with each application. In the example, in response to the position of cursor 43 over application image 56, a pop-up window 64 is displayed. In alternate embodiments, pop-up window 64 may be displayed in association with other application images, multiple pop-up windows may be displayed concurrently, and other types of inputs may initiate display of pop-up window 64.

Pop-up window 64 numerically qualifies the height level values of application image 56. In the example, the memory (M) usage by the application represented by application image 56 is 50% of the total memory available. In addition, in the example, the CPU usage by the application represented by application image 56 is 75% of the total CPU usage.

Advantageously, a level of transparency may be applied to pop-up window 64, such that graphical images, such as portions of windows 52 and 54, that are overlapped by pop-up window 64, may be visible in part through pop-up window 64. In addition, advantageously, when pop-up window 64 is displayed, a position adjacent to application image 56 is selected where pop-up window 64 will least obscure other graphical images.

In particular, in addition to a selection of a pop-up window to display the quantitative characteristics of each level of height associated with an application image, preferably a user may select to add quantitative characteristics directly to the display of each level of height. In addition, preferably a user may position cursor 43 over one of the levels of height of an application image and a quantitative characteristic of the single level of height is displayed within a pop-up window or within the level.

According to yet another advantage of the present invention, application images may be positioned in multiple graphical areas of graphical interface 50. In FIG. 3a, application images 56, 58, 60, and 62 are positioned along the bottom edge of graphical interface 50, within a bar 55. A user may select to reposition bar 55 along other edges of graphical interface 50. In FIG. 3b, application images 56, 58, 60, and 62 are positioned within a pull-down menu 65. Display of pull-down menu 65 is preferably only displayed in response to a user selection, such as positioning cursor 43 to select the pull-down menu or entering a particular key input.

With reference now to FIG. 4, there is illustrated a high level logic flowchart of a process and program for varying the heights of application images to indicate types of activity in accordance with the method, system, and program of the present invention. As depicted, the process starts at block 80 and thereafter proceeds to block 82.

Block 82 illustrates a determination as to the type of event that occurs. If a selection of a pop-up window is entered, then the process passes to block 83. If an adjustment to the z-order is detected, then the process passes to blocks 86 and 87. If an adjustment to a displayed resource usage is detected, then the process passes to block 88.

Block 83 depicts determining the best graphical characteristics and graphical position for the pop-up window. For example, the best graphical characteristic of the pop-up window may include a level of transparency, such that overlapped graphical elements are not completely obscured. Then, block 84 depicts displaying quantities associated with each level of height of an application image, and the process ends.

Block 86 illustrates adjusting the three-dimensional height of each application image to reflect the current z-order. Block 87 depicts adjusting the positional order of the application images to reflect the current z-order, and the process ends. In particular, block 86 and/or block 87 may be performed.

Block 88 depicts adjusting the three-dimensional height and shading of each application image to reflect the current resource usage, and the process ends.

While the invention has been particularly shown and described with reference to a preferred embodiment, it will be understood by those skilled in the art that various changes in form and detail may be made therein without departing from the spirit and scope of the invention.

What is claimed is:

1. A method for displaying application activity, said method comprising the steps of:
detecting at least one type of activity for an application image associated with an application open in a graphical interface; and
graphically adjusting a three-dimensional height of said application image in said graphical interface to represent said at least one type of activity, such that said at least one type of activity is graphically distinguished for an application.

2. The method for displaying application activity according to claim 1, said step of detecting at least one type of activity further comprising the step of:
detecting said at least one type of activity comprising at least one of a z-order of a plurality of open applications and usage of at least one resource by said plurality of open applications.

3. The method for displaying application activity according to claim 1, said step of graphically adjusting a three-dimensional height further comprising the step of:
graphically adjusting said height of said application image by at least one level.

4. The method for displaying application activity according to claim 1, said step of graphically adjusting a three-dimensional height further comprising the step of:
graphically applying at least one range of shading to illustrate said adjusted height of said application image.

5. The method for displaying application activity according to claim 1, said step of graphically adjusting a three-dimensional height further comprising the step of:
graphically specifying a quantity associated with said at least one type of activity.

6. The method for displaying application activity according to claim 5, said step of graphically adjusting a three-dimensional height further comprising the step of:
graphically specifying said quantity associated with said at least one type of activity in a graphical representation displayed adjacent to said application image.

7. The method for displaying application activity according to claim 1, said step of graphically adjusting a three-dimensional height further comprising the step of:
graphically repositioning an ordered location of said application image to represent said at least one type of activity.

8. The method for displaying application activity according to claim 1, said method further comprising the step of:
graphically displaying a plurality of application images in an order that represents at least one type of activity measured for each of said plurality of application images.

9. A system for displaying application activity, said system comprising:
a graphical user interface;
means for detecting at least one type of activity for an application image associated with an application open in said graphical user interface; and
means for graphically adjusting a three-dimensional height of said application image in said graphical user interface to represent said at least one type of activity.

10. The system for displaying application activity according to claim 9, said means for detecting at least one type of activity further comprising:
means for detecting said at least one type of activity comprising at least one of a z-order of a plurality of open applications and usage of at least one resource by said plurality of open applications.

11. The system for displaying application activity according to claim 9, said means for graphically adjusting a three-dimensional height further comprising:
means for graphically adjusting said height of said application image by at least one level.

12. The system for displaying application activity according to claim 9, said means for graphically adjusting a three-dimensional height further comprising:
means for graphically applying at least one range of shading to illustrate said adjusted height of said application image.

13. The system for displaying application activity according to claim 9, said means for graphically adjusting a three-dimensional height further comprising:
means for graphically specifying a quantity associated with said at least one type of activity.

14. The system for displaying application activity according to claim 13, said means for graphically adjusting a three-dimensional height further comprising:
means for graphically specifying said quantity associated with said at least one type of activity in a graphical representation displayed adjacent to said application image.

15. The system for displaying application activity according to claim 9, said step of graphically adjusting a three-dimensional height further comprising:
means for graphically repositioning an ordered location of said application image to represent said at least one type of activity.

16. The system for displaying application activity according to claim 9, said system further comprising:
means for graphically displaying a plurality of application images in an order that represents at least one type of activity measured for each of said plurality of application images.

17. A program for displaying application activity, residing on a computer usable medium having computer readable program code means, said program comprising:
means for detecting at least one type of activity for an application image associated with an application open in a graphical interface; and
means for enabling a graphical adjustment of a three-dimensional height of said application image in said graphical interface to represent said at least one type of activity, such that said at least one type of activity is graphically distinguished for an application.

18. The program for displaying application activity according to claim 17, said program further comprising:
means for detecting said at least one type of activity comprising at least one of a z-order of a plurality of open applications and usage of at least one resource by said plurality of open applications.

19. The program for displaying application activity according to claim 17, said program further comprising:
means for enabling a graphical adjustment of adjusting said height of said application image by at least one level.

20. The program for displaying application activity according to claim 17, said program further comprising:
means for enabling a graphical application of at least one range of shading to illustrate said adjusted height of said application image.

21. The program for displaying application activity according to claim 17, said program further comprising:
means for controlling a graphical specification of a quantity associated with said at least one type of activity.

22. The program for displaying application activity according to claim 21, said program further comprising:
means for controlling a graphical specification of said quantity associated with said at least one type of activity in a graphical representation displayed adjacent to said application image.

23. The program for displaying application activity according to claim 17, said program further comprising:
means for enabling a graphical repositioning of an ordered location of said application image to represent said at least one type of activity.

24. The program for displaying application activity according to claim 17, said program further comprising:
means for enabling a graphical display of a plurality of application images in an order that represents at least one type of activity measured for each of said plurality of application images.
